(19) United States
(12) Patent Application Publication
(10) Pub. No.: US 2026/0079470 A1
(43) Pub. Date: Mar. 19, 2026

(54) ARTIFACT REDUCTION IN ADDITIVE MANUFACTURING

(71) Applicant: INTERNATIONAL BUSINESS MACHINES CORPORATION, Armonk, NY (US)

(72) Inventors: Jessica Nahulan, Markham (CA); Carolina Garcia Delgado, Zapopan (MX); Perla Guadalupe Reyes Ramirez, Zapopan (MX); Silvia Cristina Santa Ana Velasco, Guadalajara (MX); Jonathan Cottrell, Canandaigua, NY (US)

(21) Appl. No.: 18/884,757

(22) Filed: Sep. 13, 2024

(51) Int. Cl. G05B 19/4099; B29C 64/118; B29C 64/194; B29C 64/20; B29C 64/393; B33Y 10/00; B33Y 30/00; B33Y 40/20; B33Y 50/02; G06T 7/00; G06T 7/73

(52) U.S. Cl. CPC G05B 19/4099; B29C 64/118; B29C 64/194; B29C 64/20; B29C 64/393; B33Y 10/00; B33Y 30/00; B33Y 40/20; B33Y 50/02; G06T 7/001; G06T 7/74; G05B 2219/49023; G06T 2207/10048; G06T 2207/30144

(57) ABSTRACT

A computer-implemented method for artifact reduction in additive manufacturing includes monitoring an image of a printing process of an object being printed to detect stringing on the object and recognizing strings on the object in the image. The strings are mapped on the object on a map within a frame of reference relative to the object. The strings are removed from the object in accordance with the map.

### BACKGROUND

The present invention generally relates to additive manufacturing and, more particularly, to systems and methods for three dimensional (3D) and four dimensional (4D) printing methods that reduce artifacts, such as strings from the printing process.

As 3D and 4D printing technologies advance, a greater number of industries and applications rely on their use to optimize fabrication processes. While 3D/4D printing provides rapid realization of printed objects or prototypes, materials/smart materials for additive printing are expensive. 3D and 4D printing can result in the generation of stringing on object or prototype creation. Stringing, a waste material, occurs when there are small strings of plastic left behind on a 3D printed model. 3D/4D printing can generate stringing when retraction settings or temperature settings are incorrectly set (e.g., set too high). In many cases, the stringing needs to be removed or can lead to having to re-print the model resulting in loss of time and filament resources.

### SUMMARY

In accordance with an embodiment of the present invention, a computer-implemented method for artifact reduction in additive manufacturing includes monitoring an image of a printing process of an object being printed to detect stringing on the object and recognizing strings on the object in the image. The strings are mapped on the object on a map within a frame of reference relative to the object. The strings are removed from the object in accordance with the map.

In accordance with another embodiment of the present invention, a system for artifact reduction in additive manufacturing includes a hardware processor and a memory that stores a computer program which, when executed by the hardware processor, causes the hardware processor to monitor an image of a printing process of an object being printed to detect stringing on the object; recognize strings on the object in the image; and map the strings on the object on a map within a frame of reference relative to the object. A robot agent is programmed to remove the strings from the object in accordance with the map.

In accordance with another embodiment of the present invention, a computer program product for artifact reduction in additive manufacturing, the computer program product comprising a computer readable storage medium having program instructions embodied therewith, the program instructions executable by a hardware processor to cause the hardware processor to monitor an image of a printing process of an object being printed to detect stringing on the object; recognize strings on the object in the image; map the strings on the object on a map within a frame of reference relative to the object; and program a robot agent to remove the strings from the object in accordance with the map.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a schematic diagram showing a system for artifact reduction in additive manufacturing, in accordance with an embodiment of the present invention;

FIG. 2 is a schematic diagram showing localization of strings or artifacts using bounding shapes, in accordance with an embodiment of the present invention;

FIG. 3 is a schematic diagram showing a map with bounding shapes and a robot agent with cutting tools, in accordance with an embodiment of the present invention;

FIG. 4 is a flow diagram showing methods for artifact reduction in additive manufacturing, in accordance with an embodiment of the present invention;

FIG. 5 is a flow diagram showing methods for concurrent removal of strings during a printing process, in accordance with an embodiment of the present invention; and

FIG. 6 is a block/flow diagram showing a system/method for artifact reduction in additive manufacturing, in accordance with an embodiment of the present invention.

### DETAILED DESCRIPTION

In accordance with embodiments of the present invention, systems and methods are described for reducing generation of stringing in additive manufacturing processes. In an embodiment, a visual stringing monitoring system is provided to collect and monitor image scans at pre-determined or ongoing intervals by a laterally installed camera or cameras. In one example, the camera can include an infrared (IR) camera. Scan data is collected and compared against an expected model outcome shape (e.g.. a standard) and against past results using a built knowledge corpus to assess the model's severity of stringing and predict areas where a majority of stringing may occur during printing. A segregation and navigation module is configured to divide the model into various movement axes for a robot agent and rank and order movement paths for travel and navigation. The segregation and navigation module identifies clusters (e.g., bounded areas) for the robot agent to remove debris including stringing material. The visual stringing monitoring system can implement methods to minimize the generation of strings created during the 3D/4D printing process. An intelligent agent or robot agent can be employed to stop the process according to defined parameters, take action to correct the process (to change settings, e.g. temperature, configuration, refill, etc.) and store excess strings to be repurposed.

In another embodiment, a training module can be employed to use crowdsourced and ongoing collected data to recalibrate a current ongoing print as well as future prints. The training module determines print settings and environmental changes to be made to mitigate stringing. The training module may also be used to optimize the robot agent's movement paths using predicted areas of likelihood for stringing based on past print results.

In other embodiments, methods for reducing resource cost of 3D/4D printing include a data model to calibrate and reduce stringing outcomes on the model. A robot agent can be employed to cut filament stringing to provide a higher quality print outcome and mitigate any potential need for a re-print. Filament material cut and collected from the stringing additive material on the 3D printed model can be recycled for use on future prints or models with lesser quality specifications.

By employing the visual stringing monitoring system in accordance with embodiments of the present invention, the 3D/4D printing system can reduce the time and material costs associated with 3D/4D printing projects. This could be especially valuable for large-scale 3D/4D printing projects, where even small improvements in efficiency can result in significant cost-savings. By identifying and resolving stringing issues in 3D/4D printed models to prevent future stringing, higher quality 3D/4D printed products can be realized with fewer defects and failures. While the present embodiments are applicable to any 3D/4D printing, industries that could especially benefit from the visual stringing monitoring system can include manufacturing, aerospace, and automotive industries or wherever 3D/4D printing is used to produce a wide range of parts and products.

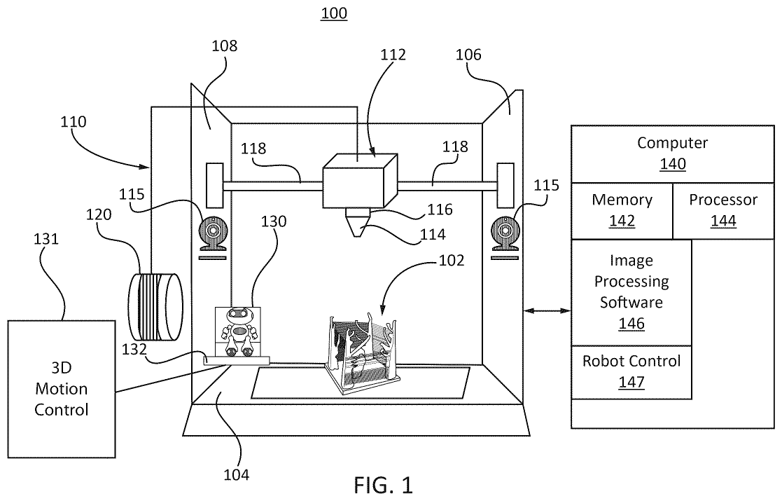

Referring now to the drawings in which like-numerals represent the same or similar elements and initially to FIG. 1, a schematic diagram shows a printer 100 for additive printing. Although 3D/4D printing is specifically contemplated, printing, as described herein, may include any appropriate type of additive manufacturing. The printer 100 includes a visual stringing monitoring system 110 which can evaluate a model 102 or object to be printed for strings and other artifacts. The model 102 is shown on a printing table 104 where the model 102 or object to be printed rests. The printer 100 can include upright portions 106 and 108, which can include drives (not shown) for x, y and z direction movement of a print head 112 during printing. The print head 112 includes an extruder 114 and a heater 116. The print head 112 is controlled and positioned to print the model 102 or object.

A filament or filaments 115 can be stored in a cache in one or both of the upright portions 106 or 108 and fed along a material conveyer(s) 118 to the print head 112. The material conveyers 118 can also support the print head 112 and permit directional motion of the print head 112. It should be understood that other printing configurations can be employed and are contemplated for use in accordance with embodiments of the present invention.

The visual stringing monitoring system 110 includes a camera 120 to scan the model 102 during the printing process and/or after the printing process as an inspection of the model 102. In some embodiments, multiple cameras can be employed to get different perspectives on the model 102. In some embodiments, infrared cameras can be employed to get a heat signature on the model 102. Heat information can be particularly useful in identifying strings as the string can have a repeatable heat signature making them easier to identify. In addition, since the strings are usually thin, they cool faster than other parts of the model and can therefore be more easily distinguished. In an embodiment, visual and infrared cameras can be employed together to further improve identification of the strings or artifacts.

A robot agent 130 can employ scan data from the camera 120 or include its own machine vision to detect the presence of strings or other artifacts. The robot agent 130 can be disposed on an agent platform 132. The agent platform 132 includes 3D motion control 131 that can provide motion in the x, y and z directions. The 3D motion control 131 of the agent platform 132 can be mounted on a robot arm or can be included on motion stages to permit motion about the model 102.

In an embodiment, the camera 120 can provide input to a computer 140 that includes memory 142 and a processor 144. Comparison software 146 stored in the memory 142 can be employed to compare current images with stored images to determine an appearance of stringing. For example, a pristine image of the model 102 or standard can be compared to a current image to detect stringing. An alarm can be programmed for when stringing is detected. Once stringing is detected, the camera 120 identifies the location of the strings on the model 102. An image of the model 102 can be divided into axes for a coordinate system or other reference system to assist the robot agent 130 in locating the strings on the model 102. In an embodiment, the visual stringing monitoring system 110 can employ machine vision and artificial intelligence to identify the strings or artifacts on the model 102.

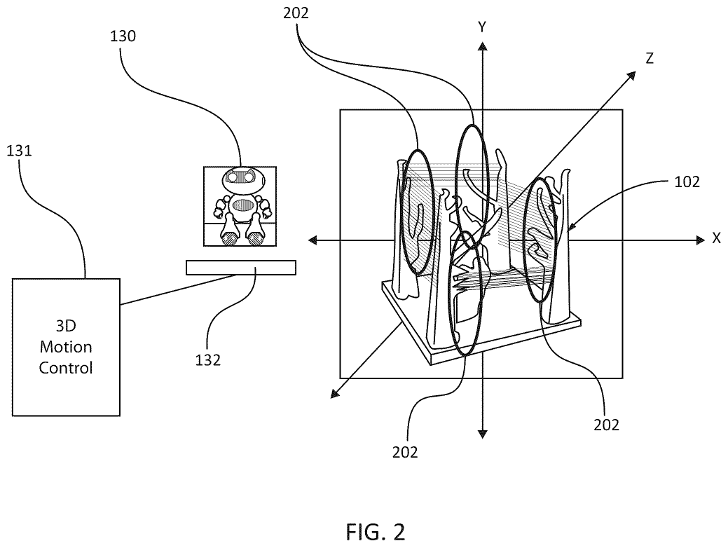

Referring to FIG. 2 with continued reference to FIG. 1, once strings are recognized, the visual stringing monitoring system 110 will provide demarcations on the scanned images. In an example, bounding shapes 202 are created in areas where higher density of stringing is determined. The bounding shapes 202 can be based on axes lines e.g., X, Y, Z in FIG. 2. The axes lines X, Y and Z can assist in guiding the robot agent 130 to the bounding shapes 202 and to assist in setting up cutting mechanisms for clearing away any strings. A map of the bounding shapes 202 can be created with a distance that the agent platform 132 has to move to remove all the strings in each bounding shape 202. The agent platform 132 can move the robot agent 130 in any direction. Additional degrees of freedom including rotations, etc. can be also provided. The scanned images of the camera 120 can be employed to provide the positions of the strings based on an analysis/comparison of the images. For example, an image can be analyzed to identify strings by comparing the image to a model image without strings. The strings can be identified and their position relative to a reference position computed.

The agent platform 132 and the robot agent 130 can be programmed and controlled using a robot control module 147 stored in the memory 142 of the computer 140. The robot control module 147 can include program code that controls the motion and cutting activities of the robot agent 130 in accordance with a particular printing process and/or model 102.

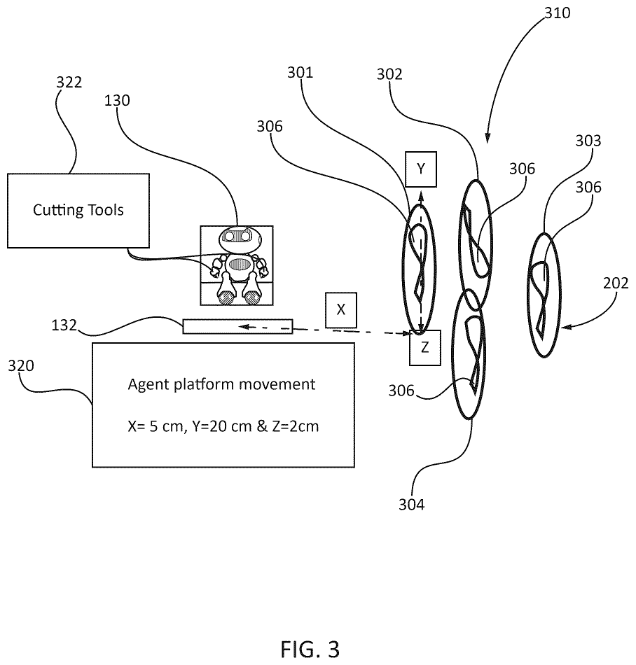

Referring to FIG. 3, a map 310 of the bounding shapes 202 can be created with positions relative to the reference position (e.g., coordinate system) determined. The positions can be stored in a memory for stored positions 320. These stored positions 320 will provide guidance to the agent platform 132 indicating where the agent platform 132 needs to move to remove all the strings 306 in each bounding shape 202. For example, for a bounding shape 301, the agent platform 132 has to move in accordance with the stored position 320, e.g., X=5 cm, Y=20 cm and Z=2 cm. The robot agent 130 then provides remediation, as needed, which can include removing strings 306 from the model 102 or removing other artifacts. The robot agent 130 then moves onto a next bounding shape 302, followed by a next bounding shape 303 and then bounding shape 304, etc. The robot agent 130 provides remediation, as needed, at each bounding shape. The sequence can be optimized using historical data and machine learning to determine a best sequences to clear the strings.

Once the agent platform 132 moves the robot agent 130 to the stored position 320 in accordance with the distance needed (e.g., in the X, Y, and Z direction), cutting tools 322, such as e.g., knives, lasers or other tools can be activated to remove the strings 306 from the model 102. The strings 306 can be collected for recycling. For example, excess strings can be collected and stored for use on designs that may have less stringent requirements.

Data regarding the removal of strings can be collected and stored in the computer 140 (FIG. 1). Information such as a number of strings 306, a number of locations (stored positions 320) on the model 102, even the weight of removed strings can be stored and employed for optimization of the process. For example, the weight of the strings can be measured as feedback on the amount of stringing a process has. A decrease in the weight of the stringing can be employed as a metric for optimization.

The computer 140 can review printer settings, including, e.g., temperature, configurations, refill data, etc. and can recalibrate the printer 100 based on historical similar prototypes that did not generate strings. The process can be tweaked by employing artificial intelligence, feedback metrics, etc. to optimize a combination of parameters that will reduce stringing to a minimum.

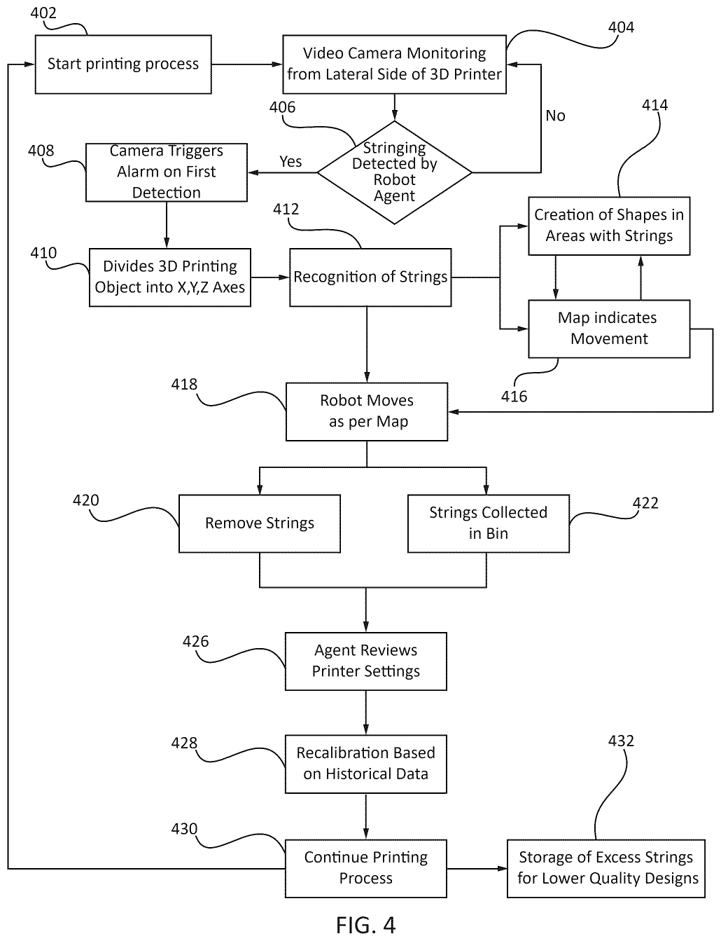

Referring to FIG. 4, a flow diagram shows an illustrative printing process using a visual stringing monitoring system in accordance with embodiments of the present invention. In block 402, a printing process starts. In block 404, a model or prototype is printed while a video camera, installed at a lateral side of the 3D printer, captures images of the printing process. In block 406, the camera and a robot agent monitor the printing process to detect the presence of strings through the camera. If no string is detected, the process continues to block 404. If a string is detected, the camera or a computer connected to the camera triggers an alarm to indicate that stringing has been detected in block 408. In block 410, the model or 3D printing object is divided into portions or assigned axes or other coordinate system to assist in locating where strings are positioned on the model.

In block 412, image processing is performed using the video camera image and stored images to compare and identify the location of the strings in the model (3D printing object). Once strings are recognized, bounding shapes, such as, e.g., circles, are generated in the images in areas of dense strings in block 414.

In block 416, a map of the bounded shapes is generated to provide addresses for the strings on the model. The map can be created with the distance that an agent platform has to move to remove all the strings in each bounding shape.

In block 418, the robot agent is guided on the agent platform in accordance with the positions on the map. In block 420, the robot agent deploys cutting tools, e.g., knives, lasers or other tools to remove strings which are part of the model or 3D printing object. In an embodiment, the robot agent may employ a laser to cut and remove the stringing. Other trimming and removing devices to remove excess filament or stringing are also contemplated. In some embodiments, the robot agent can remove the stringing concurrently during the print process.

In block 422, the strings are collected and added into a bin of strings. The strings can be weighed as data for further training of the system.

In block 426, a review of the settings, e.g., temperature, configuration, refill status, etc. is conducted to optimize the process. The number and size of the strings can be reduced by selecting different settings that can reduce the occurrence and size of strings. Artificial intelligence tools can be employed in this optimization. By using historical data, different variations can be submitted to a machine learning model to output an improved printing process. In block 428, the settings can be recalibrated for the printer based on the optimized setting and/or based on historically similar prototypes that did not generate strings.

In block 430, the printing process can continue with a next model returning to block 402. In block 432, excess strings can be stored and reused, e.g., on designs that do not require a same level of quality.

Embodiments of the present invention can be employed in a plurality of applications. In one use case, an embodiments can include manufacturing processes for plastic parts for a variety of industries. 3D printing technology is employed to create prototypes and small runs of the plastic parts. Since a high occurrence of stringing in 3D prints results in re-prints, wasted filament, and time lost trying to clean and salvage the 3D printed models and increased costs due to wasted time and filament, embodiments of the present invention can be employed to reduce or eliminated the occurrence of stringing.

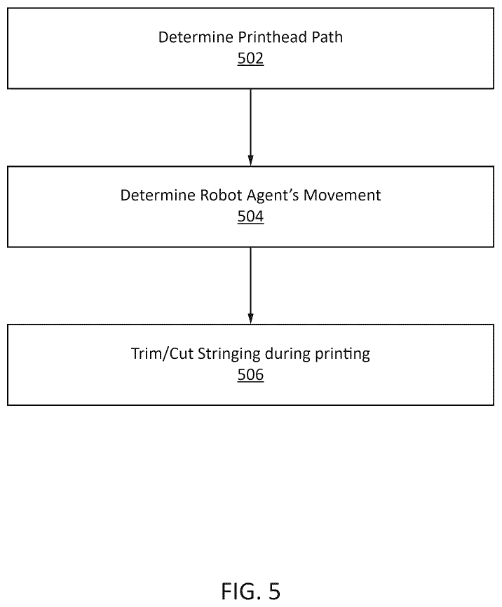

Referring to FIG. 5, an embodiment where a robot agent can remove the stringing during the print process is described. The methods described in FIG. 4 can further include the following within block 420. In block 502, future predicted motion of a printhead is computed based on G-code command movements of the printhead. In block 504, a computation is performed that takes into consideration the robot agent's movements and speeds to avoid colliding or interfering with the printhead. In block 506, during printing, stringing is cut and trimmed as it occurs during the ongoing print process. The printing process can be stopped when stringing cannot be fixed or if it may be difficult or impossible to cleanly remove the stringing if the printing process were to continue and/or complete. In some cases, it may be impossible or difficult for the robot agent to reach certain areas of the model to cleanly remove the stringing. These portions would be removed after the printing process. The robot agent's motion and trimming activities can be optimized using artificial intelligence or machine learning.

Embodiments of the present invention employ artificial machine learning systems which can be used to predict outcomes based on input data, e.g., print settings to reduce stringing, string removal sequences to optimize speed and reduce waste, etc. In an example, given a set of input data, a machine learning system can predict an outcome. The machine learning system will likely have been trained on much training data in order to generate its model. It will then predict the outcome based on the model.

In some embodiments, the artificial machine learning system includes an artificial neural network (ANN). One element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons. An ANN is configured for a specific application, such as pattern recognition or data classification, through such a learning process.

The present embodiments may take any appropriate form, including any number of layers and any pattern or patterns of connections therebetween. ANNs demonstrate an ability to derive meaning from complicated or imprecise data and can be used to extract patterns and detect trends that are too complex to be detected by humans or other computer-based systems. The structure of a neural network is known generally to have input neurons that provide information to one or more “hidden” neurons. Connections between the input neurons and hidden neurons are weighted, and these weighted inputs are then processed by the hidden neurons according to some function in the hidden neurons. There can be any number of layers of hidden neurons, and as well as neurons that perform different functions. There exist different neural network structures as well, such as a convolutional neural network, a maxout network, transformers, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. A set of output neurons accepts and processes weighted input from the last set of hidden neurons.

This represents a “feed-forward” computation, where information propagates from input neurons to the output neurons. Upon completion of a feed-forward computation, the output is compared to a desired output available from training data. The error relative to the training data is then processed in “backpropagation” computation, where the hidden neurons and input neurons receive information regarding the error propagating backward from the output neurons. Once the backward error propagation has been completed, weight updates are performed, with the weighted connections being updated to account for the received error. It should be noted that the three modes of operation, feed forward, back propagation, and weight update, do not overlap with one another. This represents just one variety of ANN computation, and that any appropriate form of computation may be used instead. In the present case the output neurons provide emission information for a given plot of land provided from the input of satellite or other image data.

To train an ANN, training data can be divided into a training set and a testing set. The training data includes pairs of an input and a known output. During training, the inputs of the training set are fed into the ANN using feed-forward propagation. After each input, the output of the ANN is compared to the respective known output or target. Discrepancies between the output of the ANN and the known output that is associated with that particular input are used to generate an error value, which may be backpropagated through the ANN, after which the weight values of the ANN may be updated. This process continues until the pairs in the training set are exhausted.

After the training has been completed, the ANN may be tested against the testing set or target, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, each weight may be characterized as a weight value that is stored in a computer memory, and the activation function of each neuron may be implemented by a computer processor. The weight value may store any appropriate data value, such as a real number, a binary value, or a value selected from a fixed number of possibilities, that is multiplied against the relevant neuron outputs. Alternatively, the weights may be implemented as resistive processing units (RPUs), generating a predictable current output when an input voltage is applied in accordance with a settable resistance.

A neural network becomes trained by exposure to empirical data. During training, the neural network stores and adjusts a plurality of weights that are applied to the incoming empirical data. By applying the adjusted weights to the data, the data can be identified as belonging to a particular predefined class from a set of classes or a probability that the input data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

A deep neural network, such as a multilayer perceptron, can have an input layer of source nodes, one or more computation layer(s) having one or more computation nodes, and an output layer, where there is a single output node for each possible category into which the input example could be classified. An input layer can have a number of source nodes equal to the number of data values in the input data. The computation nodes in the computation layer(s) can also be referred to as hidden layers, because they are between the source nodes and output node(s) and are not directly observed. Each node in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . w_{n-1,} wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

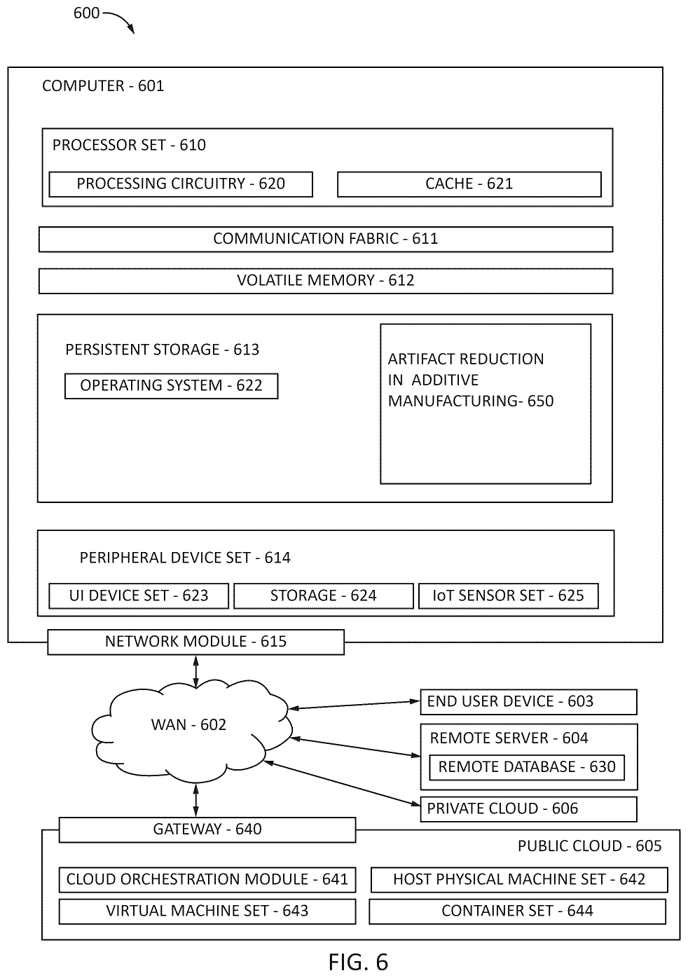

Referring now to FIG. 6, a block diagram of a computing environment is shown. Computing environment 600 contains an example of an environment for the execution of at least some of the computer code involved in performing the inventive methods, such as artifact reduction in additive manufacturing in block 650. In addition to block 650, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 650, as identified above), peripheral device set 614 (including user interface (UI) device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible.

Computer 601 may be located in a cloud, even though it is not shown in a cloud in FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in block 650 in persistent storage 613.

COMMUNICATION FABRIC 611 is the signal conduction path that allows the various components of computer 601 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, volatile memory 612 is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface-type operating systems that employ a kernel. The code included in block 650 typically includes at least some of the computer code involved in performing the inventive methods.

PERIPHERAL DEVICE SET 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 501 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602.

Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices.

Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN 602 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602. Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor-or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments for systems and methods (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented method for artifact reduction in additive manufacturing, comprising:
monitoring an image of a printing process of an object being printed to detect stringing on the object;
recognizing strings on the object in the image;
mapping the strings on the object on a map within a frame of reference relative to the object; and
removing the strings from the object in accordance with the map.

2. The method of claim 1, wherein monitoring the image includes scanning the object using a camera.

3. The method of claim 1, wherein monitoring the image includes scanning the object using an infrared camera.

4. The method of claim 1, wherein recognizing strings on the object in the image includes comparing the image to a standard to determine when stringing begins.

5. The method of claim 1, wherein mapping the strings on the object on the map includes generating bounding shapes in the image in areas of dense strings, wherein the map includes the bounding shapes and their position.

6. The method of claim 1, wherein removing the strings from the object in accordance with the map includes trimming the strings using a robot agent.

7. The method of claim 1, further comprising reviewing print settings to reduce a number and size of the strings.

8. The method of claim 1, wherein removing the strings from the object in accordance with the map includes trimming the strings using a robot agent concurrently during the printing process.

9. The method of claim 1, further comprising collecting strings removed from the object.

10. A system for artifact reduction in additive manufacturing, comprising:
a hardware processor; and
a memory that stores a computer program which, when executed by the hardware processor, causes the hardware processor to:
monitor an image of a printing process of an object being printed to detect stringing on the object;
recognize strings on the object in the image; and
map the strings on the object on a map within a frame of reference relative to the object; and
a robot agent programmed to remove the strings from the object in accordance with the map.

11. The system of claim 10, further comprising a camera to scan the object.

12. The system of claim 11, wherein the camera includes an infrared camera.

13. The system of claim 10, wherein the computer program causes the hardware processor to compare the image to a standard to determine when stringing begins.

14. The system of claim 10, wherein the computer program causes the hardware processor to generate bounding shapes in the image in areas of dense strings, wherein the map includes the bounding shapes and their position.

15. The system of claim 14, wherein the bounding shapes in the map provide positions to which robot agent is guided to remove the strings from the object.

16. The system of claim 10, wherein the computer program causes the hardware processor to review print settings to reduce a number and size of the strings.

17. The system of claim 10, wherein the robot agent removes the strings from the object using a knives.

18. The system of claim 10, wherein the robot agent removes the strings from the object using a laser.

19. The system of claim 10, wherein the robot agent removes the strings from the object concurrently during the printing process.

20. A computer program product for artifact reduction in additive manufacturing, the computer program product comprising a computer readable storage medium having program instructions embodied therewith, the program instructions executable by a hardware processor to cause the hardware processor to:
monitor an image of a printing process of an object being printed to detect stringing on the object;
recognize strings on the object in the image;
map the strings on the object on a map within a frame of reference relative to the object; and
program a robot agent to remove the strings from the object in accordance with the map.
